(19) United States
(12) Patent Application Publication
(10) Pub. No.: US 2018/0300687 A1
(43) Pub. Date: Oct. 18, 2018

(54) COMPUTER BASED TEMPORARY EMPLOYMENT PLATFORM

(71) Applicant: Neco LEWIN, North York (CA)

(72) Inventor: Neco LEWIN, North York (CA)

(21) Appl. No.: 15/490,604

(22) Filed: Apr. 18, 2017

(51) Int. Cl. G06Q 10/10

(52) U.S. Cl. CPC G06Q 10/1053; G06Q 10/1093

(57) ABSTRACT

A temporary employment platform for screening, selecting, matching and scheduling comprising of a screening engine to screen entire gathered data from an environment for a job seeker; a first-requirement database comprising of a plurality of mandatory requirements which prepares for a job posting by a verified employer, the job posting having a start time, an end time, and a date and locates in a calendar in the temporary employment platform; a second-requirement database comprising of a plurality of optional requirements which prepares for the job position by the verified employer; a first-selecting engine to select a plurality of first-candidates based on the first-requirement database; a second-selecting engine to select a plurality of second-candidates based on the second-requirement database; an executing engine to execute a plurality of elected-candidates based on the first-candidates and the second-candidates; a notification engine to notify a specific number of the elected-candidates with a timely job offer, wherein the timely job offer is expired after a predefined period of time; a fill engine to fill the job posting in the calendar, and a main database to collect data from the screening, first-selecting, second-selecting, executing, notification, and fill computer-programs.

### FIELD OF THE INVENTION

The present invention relates in general to a computer-based networking system and in particular to a computer based temporary employment, venue rental, and event planning platform.

### BACKGROUND OF THE INVENTION

Social networking platforms and websites have simplified communications among people and have allowed rapid exchange of information among them. Such platforms are also used for employment purposes. Such rapid information exchange is very useful for hiring temporary employees, to make for different working shifts or replace sick or absent employees.

Businesses may prefer to hire staffs through employment agencies, since such agencies provide a screening function for potential employers. Such agencies may be especially useful for temporary employment, since the agencies may find employees for any particular hours the employer may ask for, and even organize employer's shifts in consideration of possible working hours. However, all of the currently available methods for finding temporary staffs take time and are not immediate. The presently provided system is aimed to resolve this problem.

Currently, there are a variety of websites where employers post their jobs and job seekers post their profiles. Job seekers have to spend time on the site to find a suitable job and, similarly, employers have to go through different profiles to find the right person for their job. Often, once the employee or the employer find what they wanted, they may realize certain issues, such as distances being too far, that would make the job unacceptable.

Therefore there is a need for a computer-based networking system to connect employers (owners and managers of businesses) with job seekers in a niche market, which is more efficient, less time consuming and has a higher success rate matching the needs of both groups.

### SUMMARY OF THE INVENTION

The present invention is a computer-based recurring and temporary employment, and venue rental platform to connect individuals and businesses in relation to recurring scheduling (scheduling in-house staff), temporary employment (hiring outside staff), and venue rental. The invention provides a computer-based application integrated with methods of communication technologies to help managers and owner of businesses to find someone to cover a working shift within seconds, to allow a business to post their venue for event rental, and intern providing event planner (Specialty profiles) with a rental space for their events. By each owner and manager's staff enrolling for recurring scheduling, they may open up their calendars for temporary employment. Staff that is not working for a specific owner or manager would be enrolled for temporary employment only.

The platform comprises of an artificial intelligence channel to collect profile information from the employers, job seekers, and event planners (specialty profiles) who are registered in the system. The employment platform allows businesses to schedule their staff on a recurring basis. It also allows businesses to connect with other workers (experience or unexperienced) who are located near (or away) their venue and within their industry. Both employers (businesses) and employees (individuals) set up their own profiles to provide information to the employment platform. Only employer profiles verified by the employment platform are shared with others in the network and can employ staff outside of their venue.

The employees are able to view the profile of a business (a manager or owner of a venue) and any postings. The employers (managers and owners of the venues) are able to view employees' profiles, schedule events, post events, switch shifts, cancel events/shifts, and rate and pay new temporary employees. Employers can create postings for events, which will be available for all employees (outside staff only) (according to position type) to view and request for work, while schedule their in-house staff for the same event. Employers can also create postings for their venues rental. The present employment method allows users to search for only employers or venues specifically related to the position specified during enrollment. For example, when an employee has indicated that he/she is looking for “Bartender” work in certain area, the system will populate his/her site with employers (manager profiles) in the requested area who are hiring Bartenders. Specialty profiles (event planners) also have those same capabilities listed above for the employers with the exception that they are looking to rent the employers venue instead of posting for it for rent.

The employment platform provides a screening, selecting and matching system for the employers and the employees. The screening, selecting and matching system uses an artificial intelligence channel to select the employee's best match to the employer's requests and the employer's best match to the employee's requests. The screening, selecting and matching system is based on the match scores according to the information collected from the employees and employers profiles. The employment platform enables a user (employee and employer) to specify their interests. This is based on a series of information collected from the profiles of each user including: the type of position, experience, distance, availability and other specific qualifications related to each position. The employment platform will use the employee's home address, as registered on his/her profile during the enrollment, and the owner/manager's address of venue, as registered in their profile, to calculate the distance between each staff and venue. This function will appear on all search results including postings and scheduling. For specialty profiles, the algorithm will pick up the address based on the venue rental for employee search results.

The employment platform enables the employee to have access to a list of all employees linked to the same venue. This allows one employee to switch shift with another employee, if both employees have the same position type and the employer agree. Only employees who are verified and linked to a venue can switch a shift.

The present employment platform provides a communication channel between all users. The communicated information is collected by the platform and is used to update the screening, selecting and matching system of the present invention. The users' behavior, likes and dislikes are analyzed with the present employment platform to later help employers to find employees with their specific requirements. It also helps employees to find employers who are compatible with them.

The present employment platform comprises of processors adapted to execute instructions for matching the businesses with potential employees; a memory unit to store all profile information; and a plurality of input/output devices to input information and update the platform. The devices for communication and usage of the employment platform comprise of computers, cell phones, tablets or any smart devices capable of connecting to the internet according to the present invention. This also applies to businesses connecting with event planners and vice versa, as well as event planners connecting with potential employees.

The present employment platform further has a verification process. Each venue (owner/manager of a business) which enrolls on the platform is verified through a series of regulations. During enrollment, the owner/manager must enter their registered business number. The platform performs a search on gov.ca with said business number to confirm the business name and address of the registered business. Furthermore, a meeting with a representative of the present platform to confirm the venue exists and verifies the user of the venue profile. Once an owner/manager profile is verified, it will receive a verification tag from an enrollment system and will be consider as a verified venue in the platform. The platform will further consider an employee as a verified employee, if the employee is verified/linked to a verified venue or has been scheduled for a minimum of 10 shifts through the platform in a specific position type. A profile tag should specify the experience and the venue name for those verified as experienced by an owner/manager. Specialty profiles will undergo the same validation process as the owners/managers.

Since, employers are generally owners, managers, or event planners; they will have the same rights. They are able to schedule, post and cancel event or shifts, rate and pay the temporary employees. The owners are able to verify or un-verify managers and staff (employee) profiles (staff profiles can only be un-verified by owner/manager profiles if they were the ones who originally verified them). An owner profile will take on all of the same duties as a manager with all areas of responsibility when a manager profile does not exist. Once a manager is enrolled and verified to an owner profile/venue the owners will still have all the same rights for that area of responsibility however, the ownership falls on the manager profile. Owner profiles are classified by venue type in the platform. Manager profiles are classified by venue type and responsibilities. And the employee profiles are classified by the venue type and the position type. Event planners can also verify employees however this does not earn them an experience tag. Once employees are scheduled for 10 shifts by the event planner and earning a minimum of $50 each shift, they will be tagged as experienced. If the employees are scheduled by an owner/manager, the 10 shift minimum without dollar value applies towards experience.

The present invention further comprises of a calendar, which is linked throughout the platform to provide manager, owner, and event planner profiles with the capability of: viewing staff availability, scheduling shifts, posting events. Managers, owners, event planners and staff profiles will use the calendar to keep track of scheduled events. Owner/manager calendars will display all events booked by managers verified to their venue as well as event planners renting their venue. The calendar also allows staff profiles to view their co-workers availability when switching shifts. Owner, manager and event planner profiles can switch/cancel shifts for staff that they have personally scheduled.

The calendar of the present invention is capable to notify the owner or the manager of a venue or an event about any scheduled events with all the staffs responsible for the event. Also, make sure that the number of employees is the same as that requested by the owner, manager or event planner. The owner/manager and event planner through the calendar of the present invention is capable of requesting a job posting to immediately hire a staff.

Staff profiles can give away shifts to any employee of the same venue who is available for the duration of the shift. Only users who are available for the full duration of an event will be able to be scheduled. Staff profiles can still view postings for dates that are unavailable in their calendars through the search function and their favorites.

The rating and payment procedure in the system is worked so that the owners, managers and event planners rate and pay outside staff after a shift. Therefore, other managers/owner/event planners can immediately assess the staff's abilities based on previous ratings. Also, the staff would receive funds electronically within 24 hours through the employment platform.

Manager/owners/event planners are able to add a maximum number of requests that they can receive on each posting. Once scheduling is completed, the job posting is terminated.

Notifications are received for all activities regarding each profile. Notifications include but not limited to: validation requests, validation confirmation, shift requests, shift confirmation (accepted or not accepted), shift cancellation, shift updates (notes updated on the event by owner/manager/event planner—staff notification only), shift switch, postings by favorite venues (staff notification only), events taken place, rate/pay reminder, request to rent venue (owner/manager only), and venue rental confirmation (event planner only). Owners can receive all notification that managers receive, if they are scheduling staff, otherwise they will only receive validation request notifications.

The platform automatically sets a reminder for all bookings occurring for anything over 24 hours. Reminders will be set for five hours prior to booking start time. Users can set their own reminders. Once a reminder is set by a user, the automatic reminder will be cancelled out. Reminder option is placed on every booking confirmation/switch shifts (essentially anything that goes into the user's calendar).

It is an object of the present invention to immediately connect employers who are seeking temporary workers to experienced or unexperienced job seekers. The present platform can reduce job placement to within few minutes.

It is another object of the present invention to provide a selected group of potential employees, who are available for a certain work shift, and are highly compatible with the employer's requirements.

It is another object of the present invention to connect employers and employees who are closely located with respect to each other. This will reduce travel time and allows immediate job placement.

It is another object of the present invention to provide a calendar system in the platform to enable employers to search for available temporary employees on specific dates.

It is another object of the present invention to enable job seekers to instantly pick up shifts and work wherever and whenever they wish.

It is another object of the present invention to provide an employment platform to review job seeker profile information, including pictures of the individuals, specific information (height, weight, etc.) and/or their previous work experience, reviews, references and availability.

It is further another object of the present invention to provide a rating and review section to view employer's reviews regarding an employee.

It is another object of the present invention to enable job seekers to post availability dates and/or times and enables employers to offer a work to a job seeker. Both the employer and the job seeker are able to leave a feedback about their experience in a rating section.

It is another aspect of the present invention is to connect the employers with the job seekers who have a special skills and experience that matches the requirements of the employees.

It is another aspect of the present invention to allow employers to create events while easily scheduling staff by specifying a date, time and the position type(s) required. Based on those specifications, the present invention will provide all available staff options to the employer, consisting of in-house and outside staff.

Another aspect of the present invention is to connect employers (business') of a venue with specialty profiles (event planners) for rental of the venue property pertaining to events outside of the business' events. As well as to allow specialty profiles to find job seekers on behalf of the venue if they choose to.

### BRIEF DESCRIPTION OF THE DRAWINGS

Embodiments herein will hereinafter be described in conjunction with the appended drawings provided to illustrate and not to limit the scope of the claims, wherein like designations denote like elements, and in which:

FIG. 1 shows a schematic diagram of the temporary employment platform of the present invention;

FIG. 2 shows a schematic diagram of the job offer requirement data base of the present invention;

FIG. 3 shows a schematic diagram of the venue package requirement database of the present invention;

FIG. 4 shows a schematic diagram of the enrollment process of the present invention;

FIG. 5 shows a schematic diagram of the temporary employment platform for manual selection of job posting;

FIG. 6 shows a schematic diagram of the staff landing page of the present invention;

FIG. 7 shows a schematic diagram of venue/specialty profile (event planner) setup platform of the present invention; and

FIG. 8 shows a schematic diagram of the manager/owner landing page of the present invention.

The figures are not intended to be exhaustive or to limit the present invention to the precise form disclosed. It should be understood that the invention can be practiced with modification and alteration, and that the disclosed technology be limited only by the claims and equivalents thereof.

### DETAILED DESCRIPTION OF PREFERRED EMBODIMENTS

The technology disclosed herein, in accordance with one or more various embodiments, is described in detail with reference to the following figures. The drawings are provided for purposes of illustration only and merely depict typical or example embodiments of the disclosed technology. These drawings are provided to facilitate the reader's understanding of the disclosed technology and shall not be considered limiting of the breadth, scope, or applicability thereof. It should be noted that for clarity and ease of illustration these drawings are not necessarily made to scale.

The “Staff” in the present invention is a temporary job seeker and is referred to an individual seeking for a temporary work, for a limited time, generally for a day, a part of a day, or for several days, or for one or more weeks. Staff can also be individuals scheduled for permanent employment when verified by a specific venue. A business owner in the present invention is referred to an “Owner” who is seeking for temporary workers for a specific date and time or rental of their venue for a specific date and time. A “Manager” in the present invention is referred to an individual hired by the business owner or an employment agency hired by the business owner which seeks temporary workers on the owner's behalf. Owner profile has all the same rights as a manager profile in the present invention. Both owner and manager profiles make up the “venue”. Specialty profiles referred to as “Event Planners” are individuals seeking venue rental space for events as well as staff for temporary employment. These profiles are similar to owner/manager profiles as they're both employers.

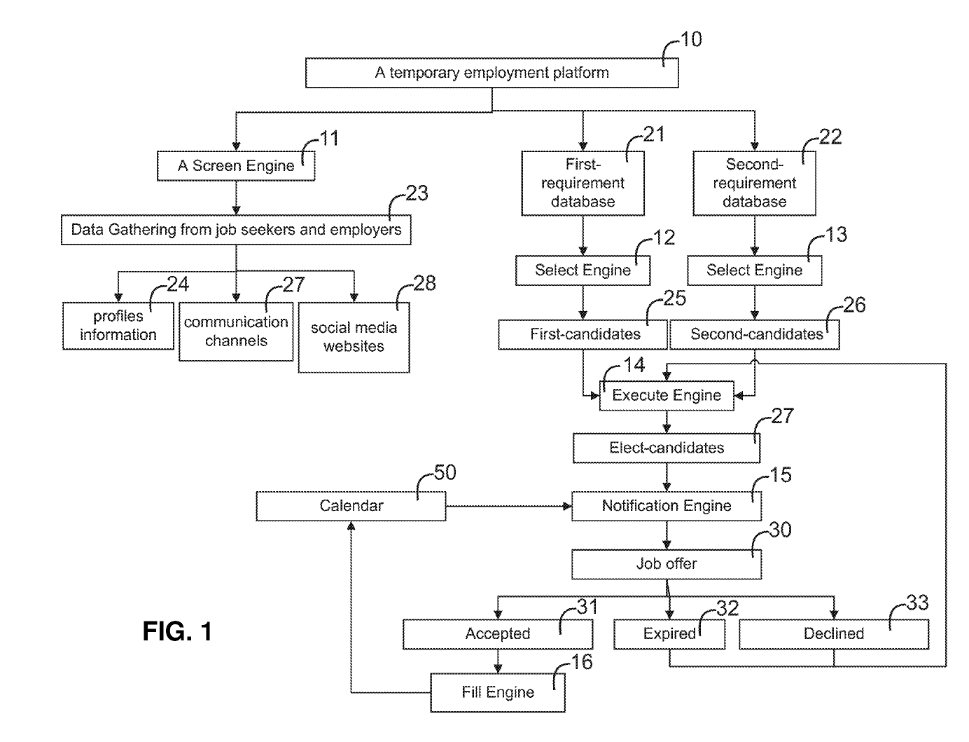

Referring to FIG. 1, a temporary employment platform 10 for screening, selecting and matching to find a temporary candidate for a job offer comprising of a screen engine 11 to screen entire gathered data from job seekers and employers 23 for a job offer, wherein the gathered data is collected from a profile information 24, a communication channel 27, and a social media website 28.

In the present invention 10, the screen engine 11 has an artificial intelligence platform which screens and perceives all data gatherings 23 (profile information 24, communication channels 27, other social networking website 28, comments, likes). The screen engine 11 assigns a match level for a job seeker for a specific job posting. The screen engine 11 is capable of understanding user's communications, and interpreting gathered data for the first and second selected engines 12, 13.

The temporary employment platform 10 maximizes the chance of satisfaction for the job seekers and the employers. For example, the employment platform 10 mimics employment patterns of employers, throughout massive data gathering of the previous employees, which were hired by the employer. One example of this cognitive function is given for a bartender position: For example, if the employer always hired a tall and a blond female for previous jobs, the employment platform 10 nominates the job seekers with these characteristic, by searching their profile information (e.g., physical description) and even their information in other social networks.

Again as shown in FIG. 1, a first-requirement database 21 comprising of a plurality of mandatory requirements (previous experience, qualification, level of education, availability, distance from the job and etc.) for a job offer prepared by the employer. The job offer has a start time, an end time, and a date which is shown in a calendar 50 in the temporary employment platform 10.

A second-requirement database 22 comprising of a plurality of optional requirements (physical characteristic 47, level of maturity 48, level of maturity of social media profile of the job seeker, for example the job seeker with higher followers in social media website which can promote the employer's business. And job seekers having higher performance rating based on percentage of rating and quantity of venues who've rated them in the present platform. The screen engine 11 mimics cognitive functions of the employer as that employer hires more job seekers. The screen engine 11 updates itself whenever a new job offer is placed in the calendar 50 of the employment platform 10.

Again as shown in FIG. 1, a first-select engine 12 selects a plurality of first-candidates 25 based on the first-requirement database 21 from the job seekers and a second-select engine 13 selects a plurality of second-candidates 26 based on the second-requirement database 22. The Execute engine 14 compares both first-candidates 25 and second-candidates 26 and determines the elected-candidates 27. The elected-candidates 27 are determined from common job seekers, which are common in both first-candidates 25 and second-candidates 26. If there is no common job seeker in both first-candidates 25 and second-candidates 26, the execute engine 14 determines the elected-candidates 27 from the-first candidates 25.

A notification engine 15 of the present invention notifies a specific number of the elected-candidates 27 with a job offer 30.

The elected-candidates 27 receive a job offer 30 and they can accept 31 or decline 33 the job offer 30. If accepted 31, the fill engine 16 fills the calendar 50 with the elected-candidates 27 and notification engine 15 notifies the employer about elected-candidate job offer 30 acceptance 31. If the elected-candidates 27 declines 33 the job offer, 30 it will return to the employer to prepare a new job offer 30 and send it to a new elect-candidate 27. The job offer can also be posted by the employer, so that the job seekers can request to work (the job posting also go through the first and second set of requirements, first and second selecting computer program, executing computer program, and notification computer program to find the best job seekers). Employer receives notification and then accepts or declines the request. A maximum number of requests is specified during the setup of the job posting. Once maximum number of requests is reached, the posting is removed (expired). The employer will then have to review each request and accept/decline. If not all requests are accepted, those declined will re-open the posting for more requests until the maximum number of requests is reached again. This process will continue until the required employees are hired. Once all employees are hired, job posting is completed by the employer and moved into the job seekers and employers calendars. Job seekers will also receive notification of request acceptance.

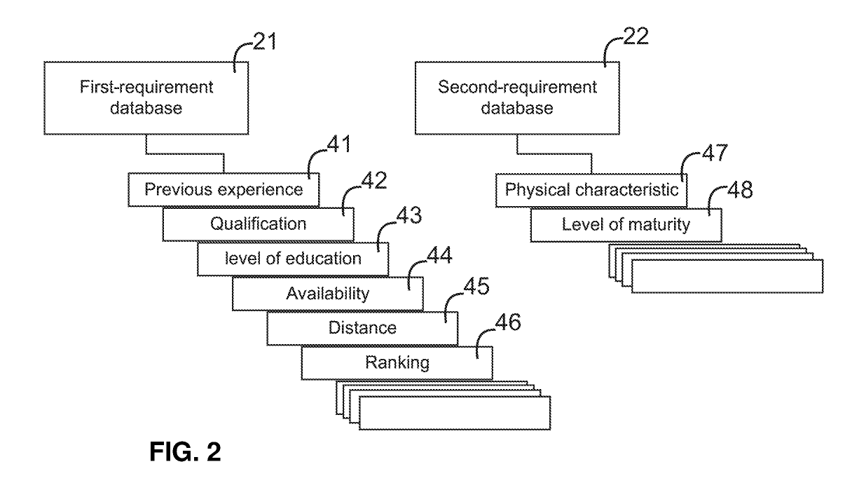

As shown in FIG. 2, the first-requirement database 21 is determined for each position by the employer, the first-requirement database 21 is based on series of information collected from the profile information of each job seeker including: previous experience 41, qualification related to each position 42, level of education 43, availability 44, distance from the job 45, ranking of each profile 46 and etc. The second-requirement 22 is determined for each position by the employer; the second-requirement database 22 is based on series of information collected from a plurality of optional requirements such as physical characteristic 47, and level of maturity 48. Some of the information can be collected from the user's profiles and some of them are based on the gathered information by the screen engine through the communication channels and other social media websites.

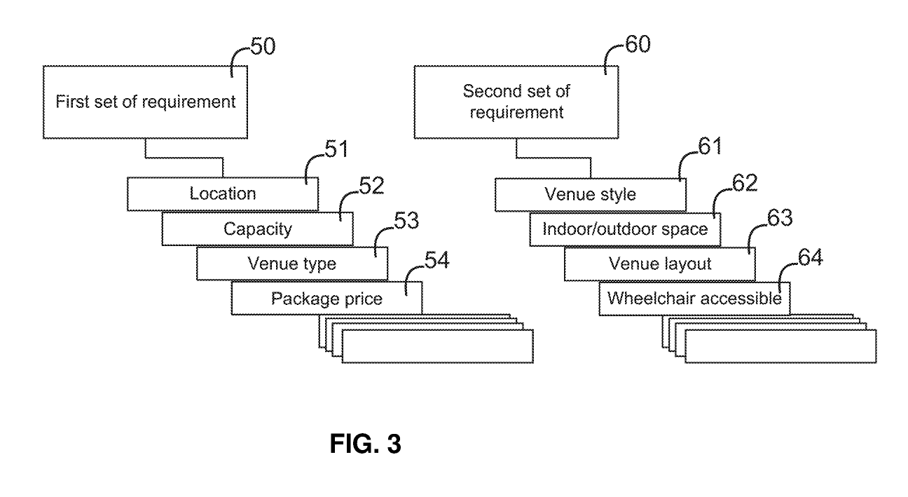

FIG. 3 shows a schematic diagram of the venue package requirement database of the present invention. The first set of requirements 50 for the venue selection comprises of location 51, capacity 52, venue type 53, and package price 54. The second set of requirements 60 for the venue selection comprises of a venue style 61, indoor/outdoor space 62, venue layout 63 (for first and second floor) and wheelchair accessible 64.

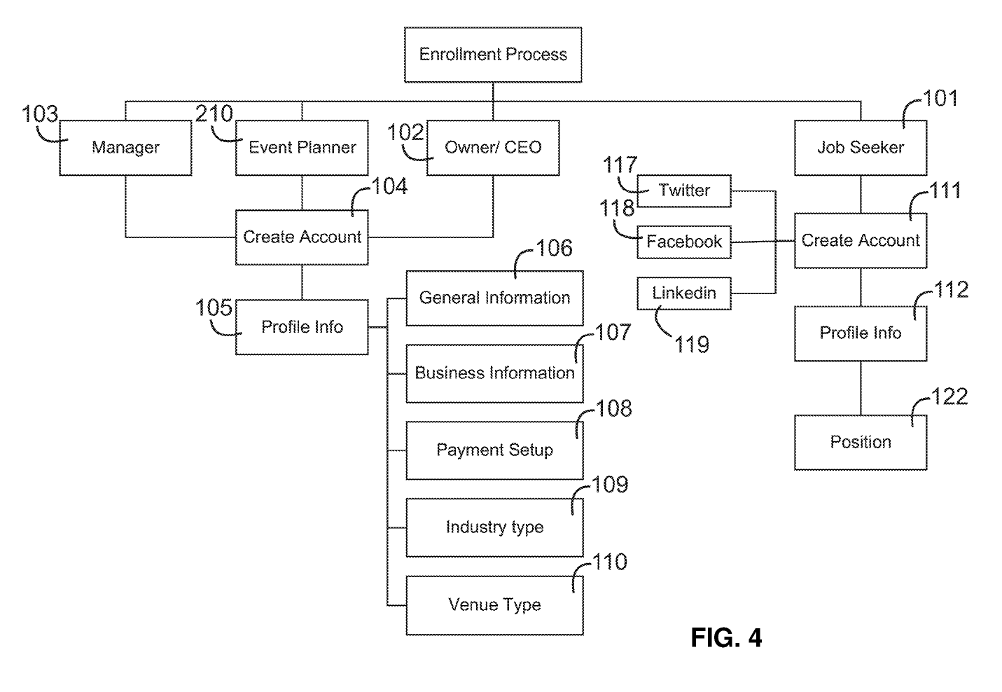

Referring to FIG. 4, the user enrolls in the system as a job seeker 101, owner 102, or manager 103 of a business or an event planner 210. If the owner 102 or manager 103 enrolls, once the profile type is selected, the manager 103/owner 102 creates an account 104 and sets up a profile 105. The profile information includes: general Information 106 such as name, email address, and password; business information 107 such as name of the company, address, registered business number, capacity etc.; payment set-up 108 such as credit card type, name, number, etc.; industry type 109 such as service industry; and venue type 110 such as a night club, a lounge, a bar, etc.

As shown in FIG. 4, if an event planner 210 enrolls, once the profile type is selected, the event planner 210 creates an account 104 and setups up a profile 105. The profile information includes: general information 106 such as name, email address, and password; business information 107 such as name of company, address, registered business number, etc.; payment set-up 108 such as credit card type, name, number, etc.; and industry type 109 such as service industry.

The job seeker 101 creates an account 111 and provides the profile information 112 including email and password, address, name and gender and other specific information which are relevant for the special jobs. The job seeker 101 will have access to the positions 122 which are available in the system 10. As shown in FIG. 4, the system allows the job seeker 101 to enroll through other social media such as twitter 117, Facebook 118, or LinkedIn 119.

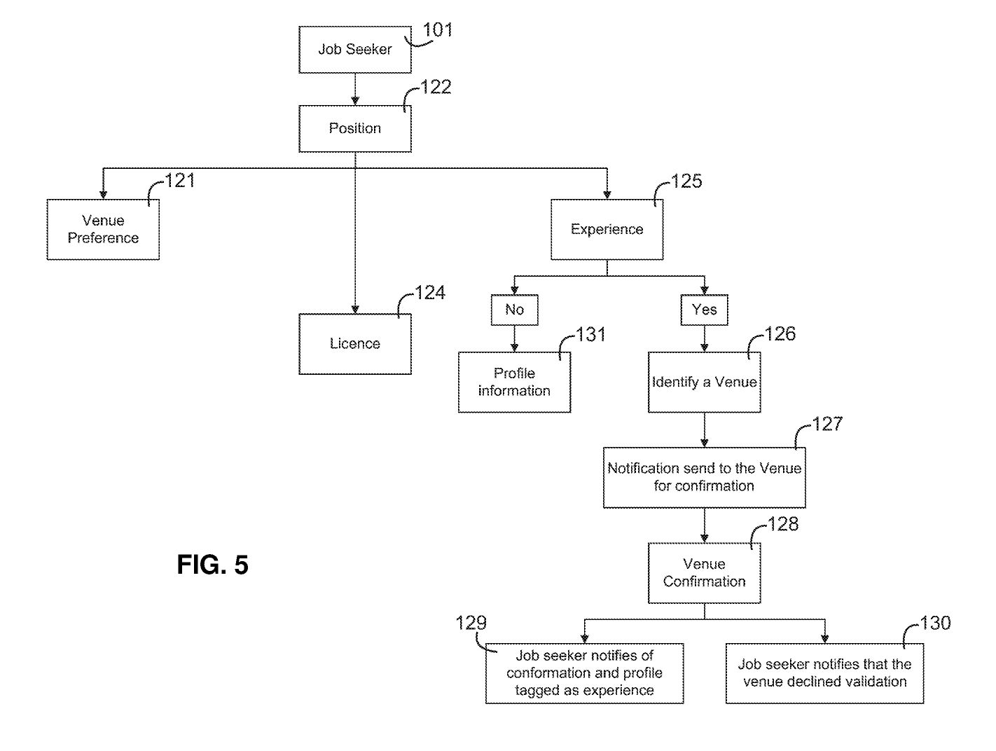

As shown in FIG. 5, the job seeker 101 can request to work a job posting that he/she is interested in based on their position 122 and the position required by the venue 121. The system checks the match level of the job seeker and if it passed the threshold of requirement; the system notifies the employer about the request. The employer, after reviewing the job request, can accept or decline. If accepted, job seeker will be scheduled.

The job seeker will be considered as an experienced job seeker, if he/she has been scheduled for a minimum of 10 shifts by a venue. They may also be considered as an experienced job seeker if they request validation from the venue that he/she works for 126. A notification will be sent to the venue for confirmation 127, 128. Once accepted, a profile tag should specify the job seeker as an experienced job seeker providing the information of all venues 129. Experienced job seeker must work a certain number of shifts (e.g., 10 shifts) through the employment platform in order to keep his/her experience tag if they are no longer working for the venue they were verified by. The venue can also decline the verification 130.

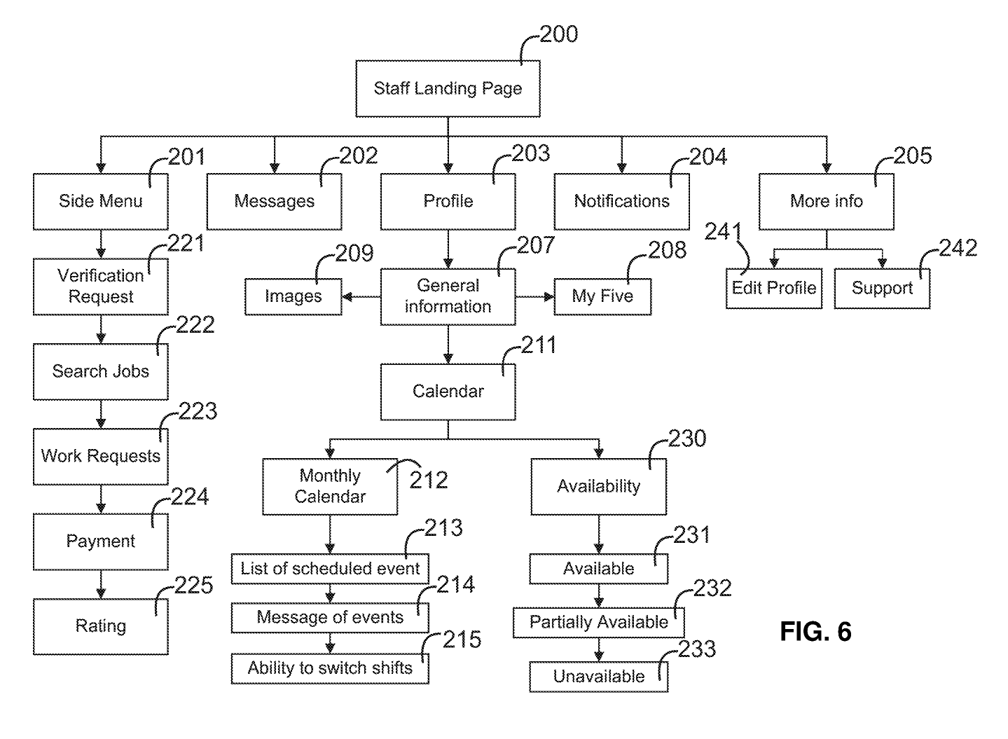

As shown in FIG. 6, a user enrolled as a job seeker in the system is led to the staff landing page 200. The staff landing page 200 comprises of side menu 201, messages 202, profile pages 203, notifications 204 and more info menu 205 sections (edit profile 241 and support 242). In the profile page 203, the system allows the user to upload a display picture, and if the user is verified as experienced, an experience tag will be displayed on the profile above their display picture. Other information such as distance between the staff and the venue, and rating of previous venues will also appear on the general information section 207.

A series of toggle screen menus are provided in the staff landing page including: More Info 205, staff 208, Images 209, and calendar 211. The system provides a selected list of staffs (My Five) 208 matched to the position based on the profile information. Owner/managers from all venues can use this section.

Notifications 204 are received for all activities regarding each profile other than messages. Notifications include: Owner/Manager verification requests, owner/manager and staff verification confirmation, all shift requests, shift confirmation acceptance or rejection, shift cancellation, shift updates, shift switch, postings by favorite venues, event taken and rate/pay reminders.

Again referring to FIG. 6, staff has access to the calendar 211, which is shown in a monthly basis, monthly calendar 212 including a list of all scheduled events and the details of each event 213, messages of the events 214, and ability to switch shifts 215. In the calendar 211, the staff can identify his/her availabilities 230. The staff can show that he/she is available 231 in a period of time, partially available 232, or unavailable 233.

The staff is then able to search jobs 222, view event postings and send their request to work for a shift. The staff is also able to view their work requests 223, accept or decline work requests from venues.

A rating section 225 is provided in the staff landing page used for the second-requirement-database. This section is maintained by employers rating/paying each staff once they've worked a shift in their venue. A notification will be sent to the employers requesting to rate/pay each staff. Rating can be done through the side menu after a work shift.

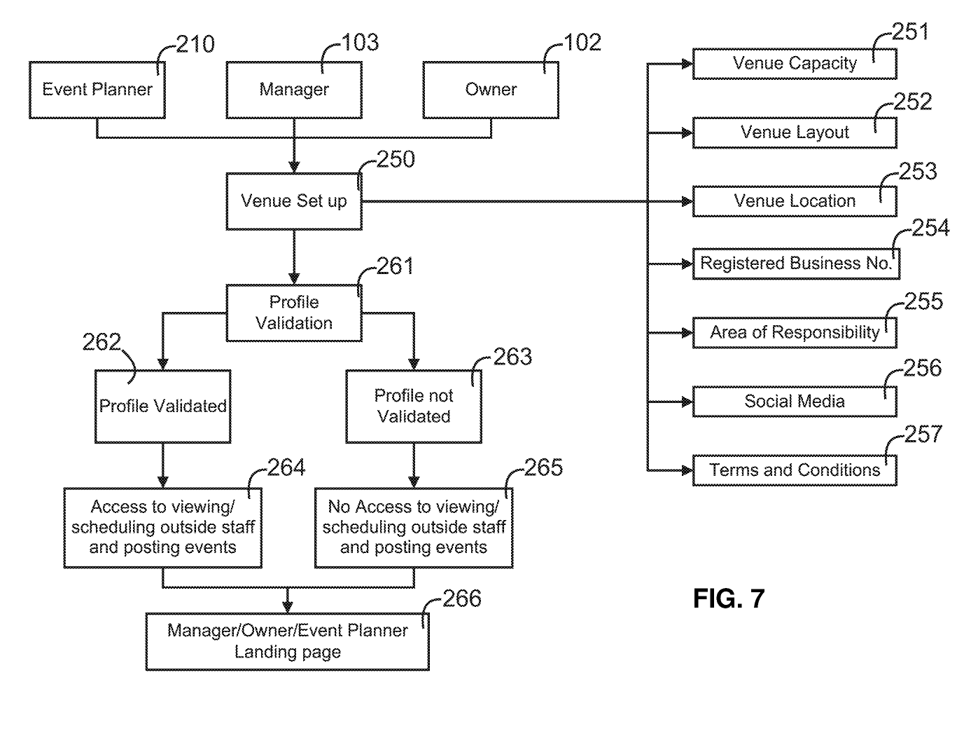

Referring to FIG. 7, as part of the owner/manager/event planner 102, 103, 210 enrollment in the system, they must complete the set up their profiles. Owner profiles are setup by venue type in the platform. Manager profiles are setup by the venue type and responsibility. Event planners are setup as default with all areas of responsibility. The manager or owner sets up venue information 250 comprising of venue capacity 251, venue layout 252, venue location 253, registered business number 254, area of the responsibility 255, links to other social media 256 and terms and conditions 257. The event planner sets up their profile information comprising of gallery picture, profile picture, name, etc.

After set up of venue/event planner is done, the system of the present invention will verify the profile 261. All owner and event planner profiles must be verified by the employment system. The system can also verify manager profiles 103 if there is no owner profile 102 assigned to the venue and both owner/manager profiles 102 can verify staff 101 profiles. Owners 102 can verify manager profiles 103 and owner/manager can verify staff profiles whether or not they are verified themselves, however if verified by a non-verified owner/manager profile, staff profiles will not be considered experienced (they will only be linked to the venue for scheduling purposes). Event planners can also verify staff profiles however the same rule applies, staff will only be linked to the venue for scheduling purposes. Once the owner/manager profile has been verified 261 by the employment platform of the present invention, those verified by the owner/manager will then be considered experienced.

If manager profile has not yet been created, the owner profile will verify the staff profile. Once manager profile is enrolled 262 and verified to the owner profile, all staff linked to the owner profile will now shift to the manager's profile based on area of responsibility (staff position type vs. manager area of reasonability).

If staff is looking for verification during enrollment, but the owner/manager of the venue have not been verified yet, the venue should still appear for verification however user should be notified that the venue they're requesting verification from, is not verified. Verified owner profile will receive a verification tag from the enrollment system and be a verified venue in the platform. If the profile is considered “not verified” the profile stays active however they do not have additional features and can only schedule in-house staff.

If a manager 103 is not verified by the owner profile of a venue, they will not be linked to that venue. This means staff verification will go to the verified owner profile. If the owner profile does not exist or is not verified either, staff verification will go to that manager however staff will not have an experienced tag. The manager can only schedule staff under their profile that they have verified as staff, and cannot post events or hire outside staffs. Verified manager profiles can setup postings and schedule outside staff profiles.

Staff verified by un-verified owner/manager will not have an experienced tag or venue name on their profiles as this verification does not mean those staff profiles are experienced, but they are employed under that owner/manager.

Non verified event planner profiles only have permissions to communicate with owner/manager for venue rental. They cannot schedule staff, post events, etc.

To receive an employment verification of the system after enrollment, once owner/manager/event planner is brought to the landing page 266, a pop up will appear to explain the benefits of having a verified profile. The Owner/manager/event planner can send their request to verify their profile. The verified owner/manager profiles have the benefits to search for any user enrolled in the platform, view all activities linked to the venue, schedule staff, post a listing to hire new staff for upcoming events that will be viewed by all users on employment system, pick potential staff for the events and public view of users profile by other users. The verified event planner profiles have the benefits of posting events, scheduling staff, rating/paying staff, etc. just as verified owner/manager profiles do.

The employment platform of the present invention receives notification of verification request. Once request is confirmed owner/manager will receive a confirmation notification. If request is declined, a message will be received by the user. As soon as industry type, address and business name matches a verified owner profile, automatic verification request should be sent to the owner as a notification. The manager profile should also receive a notification that verification has been requested. If owner joins at later date and manager profile is already verified, owner and manager profiles should automatically be linked. This only applies if the owner profile is verified by employment system. The user is taken to the manager/owner/event planner landing page 266 regardless if validated or not 262, 263, only difference is that there are more permissions for validated profiles 262 to have access to view, schedule outside staff and posting events 264.

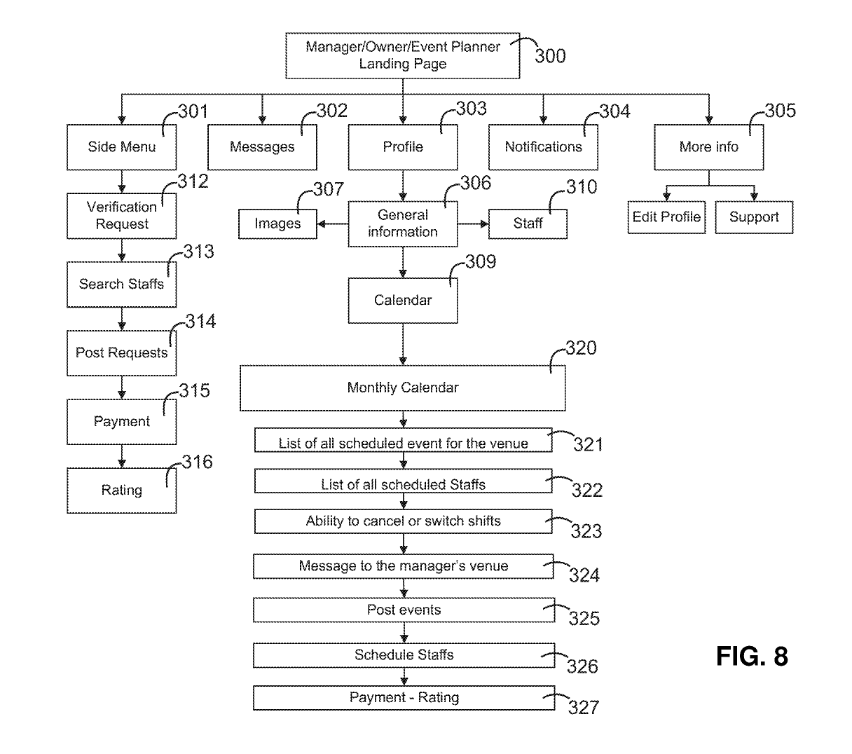

Referring to FIG. 8, the user enrolling as owner/manager/event planner is led to the manager/owner landing page 300. Manager/owner/event planner landing page 300 comprises of side menu 301, messages 302, profile pages 303, notifications 304 and more info menu 305 sections. Profile page 303 comprises of general information such as identification information which shows the owner/manager/event planner name and the area of responsibility (owner/manager only), a display picture section allows user to upload a display picture, verification tag, distance (KM) from user viewing profile and message button that only appears when anyone other than the profile owner is viewing their profile. A series of toggle screen menus are provided on the profile page including: images section 307, general information section 306, calendar section 309, and selected list of staffs section 310.

In the side menu 301, the manager/owner/event planner can search 313 for staff name, position type, personal info, and add staff to the favorites 310. Event planners can also do the same for venues. The manager/owner/event planner is able to view job postings, job offers pending confirmation, upcoming events, and staff pending rating/payment 314 as well as all event details 901. They also have access to list of previous scheduled staff and current staffs 322, 326, ability to cancel or switch shifts 323 and send messages 324. Owners/managers of the venue and event planners also have a monthly calendar 309 where they will book all events 325 (venue rental, schedule staff) or post requests to hire staff with the details including name of the event, date, shift, duration, wage, and position type, etc.), view list of all the scheduled events, and send event related messages 324.

The payment 315 and rating 316 is initiated by events in the owner/manager/event planner calendar however, payment is only applicable for staff scheduled outside of their home venue. Payment details include: date/time of the shift, rate/hour, total hour and the method of payment. If the owner/manager/event planner has not rated/paid staff within 24 hours they will receive a notification, and again in 72 hours. The system allows owner/manager/event planners to view history of staff paid and pending payments. The owner/manager/event planners rate the staff based on particular specifications such as punctuality, social, and performance of the staff. Rating can be done through notification or side menu. Payments must be done through system application and is pre-calculated based on event details and will be made at the end of shift during rating. The system includes capability for direct deposit payment from owner/manager/event planners to staff.

Manager/owner/event planners are able to add a maximum number of requests they can receive on each posting. Once the full count of staff required have responded to the posting, it should be removed from all search results. If manager/owner/event planner declines any of the requests, the posting will be listed again until the remaining staffs required submit requests.

The system also enables the user to switch a shift through the calendar. Under the staff icon of any event, user can see a list of all staff working the event based on their position type; including themselves with a “switch shift” button beside their name. Once they select “switch shift”, a list of staff with the same position type linked to their venue, and available for the duration of the shift will appear. User would then click “request” button beside staff name. Once request button is selected, user will return to calendar or side menu. Both the requestor and requested will receive a notification indicating switch shift requested. If staff confirms switch shift request, requestor and employer will receive a notification advising switch shift confirmed. The event will then be removed from one staff calendar and move into the new staff calendar. If staff declines the shift switch request, requestor will receive a notification advising switch shift declined.

Specialty profiles in the present invention platform typically belong to promoters, DJ's, event planners (wedding, concert, etc.), and agencies. For instance a promoter profile would be an individual that owner/managers will hire to bring in clientele for events. They are also capable of managing their own events and therefore enable owner/managers to rent out their venues for additional revenue on days they are not open for business. Specialty profiles share permissions from both owner/manager profiles and staff profiles. Like owner profiles, they have permissions to create events, schedule staff, rate/pay staff, etc.; and they can have manager profiles linked to them to facilitate job offers/events.

However the specialty profiles will be booking venues rather than posting venue packages for bookings. With booking of venue packages, the specialty profiles will be required to pay the venues through the platform similar to how outside staff is rated/paid, excluding the rating. Additionally, these profiles will enroll with a personal or business address, though their event addresses changes depending on the location of the event (Venue) whereas the owner/manager venue address cannot be changed. Similar to staff profiles, specialty profiles can be scheduled by owner/manager profiles and receive rating/payment through the present invention. They can also schedule on behalf of the owner/managers as this would assist in catering to a specific clientele, insurance purposes, etc. The above guidelines are general for all specialty profile types however each profile (promoters, DJs, event planners, and agencies) will also have specific features, i.e. specialty profile (Promoters) will work directly with staff profiles (Guest list) to keep track of clientele arriving at the event. The present invention uses a computer-program implemented to show the average number of clientele that a promoter profile can bring to the event.

In case of a venue rental cancellation, if cancellation occurs 48 hours or less from the event date and time, the present invention will calculate a percentage based on venue package as a penalty for the event planner. This penalty must be paid or the event planner profile will be suspended from viewing venue packages.

The foregoing is considered as illustrative only of the principles of the invention. Further, since numerous modifications and changes will readily occur to those skilled in the art, it is not desired to limit the invention to the exact construction and operation shown and described, and accordingly, all suitable modifications and equivalents may be resorted to, falling within the scope of the invention.

With respect to the above description, it is to be realized that the optimum relationships for the parts of the invention in regard to size, shape, form, materials, function and manner of operation, assembly and use are deemed readily apparent and obvious to those skilled in the art, and all equivalent relationships to those illustrated in the drawings and described in the specification are intended to be encompassed by the present invention.

What is claimed is:

1. A temporary employment platform for screening, selecting, matching and scheduling, said temporary employment platform comprising:
a) a screening computer-program implemented to screen an entire gathered data from an environment for a job seeker;
b) a first-set-of-requirements comprising of a plurality of mandatory requirements provided by a verified employer for a job posting, said job posting having a position, a date, a location, a start time, and an end time, said job posting is posted in a calendar;
c) a second-set-of-requirements comprising of a plurality of optional requirements provided by said verified employer for said job posting;
d) a first-selecting-computer-program implemented to select a plurality of first-candidates based on said first-set-of-requirements;
e) a second-selecting-computer-program implemented to select a plurality of second-candidates based on said second-set-of-requirements;
f) an executing-computer-program implemented to find a plurality of elected-candidates who appear in both said first-candidates and said second-candidates, if no candidates appears in both groups, then select from the first-candidates;
g) a notification-computer-program implemented to notify a specific number of said elected-candidates with a job offer;
h) a posting-computer-program implemented to fill said job posting in said calendar by said elected-candidate;
i) a main database to collect data from said screening, first-selecting, second-selecting, executing, notification, and posting computer-programs, and whereby the verified employer schedules the elected-candidate in the calendar and the elected-candidate is paid and rated by the verified employer.

2. The temporary employment platform of claim 1, wherein said mandatory requirements selected from the groups consisting of a previous experience, a qualification, a level of education, an availability, and a physical distance from the job seeker to the verified employer.

3. The temporary employment platform of claim 1, wherein said optional requirements selected from the groups consisting of a physical characteristic, and a level of maturity of profiles of said job seeker in a social media website and by other employer ratings.

4. The temporary employment platform of claim 1, wherein said notification computer-program further notifies said verified employer once said job posting is filled.

5. The temporary employment platform of claim 1, wherein said environment comprises of a profile information of said job seeker and said verified employer, a communication channel, and a social media website.

6. The temporary employment platform of claim 1, wherein said screening computer-program collects a set of information from said job seeker, said verified employer, said communication channel, and said social media websites, and stores said set of information in said main database.

7. The temporary employment platform of claim 1, wherein said first-selecting computer-program reviews and compares said set of information with said first-set-of-requirements, and selects a plurality of said first-candidates.

8. The temporary employment platform of claim 1, wherein said second-selecting computer-program reviews and compares said set of information with said second-set-of-requirements, and selects a plurality of said second-candidates.

9. The temporary employment platform of claim 1, wherein said temporary employment platform further having a match-level-engine to actively update a match-level assigned to said job seeker based on said job posting.

10. A method for screening, selecting and matching in a temporary employment platform comprising steps of:
a) screening entire gathered data from an environment for a job seeker;
b) selecting a plurality of first-candidates based on a first-set-of-requirements, wherein said first-set-of-requirements comprising of a plurality of mandatory requirements which prepares for a job posting by a verified employer, said job posting having a position, a start time, an end time, and a date and locates in a calendar in said temporary employment platform;
c) selecting a plurality of second-candidates based on a second-set-of-requirements, wherein said second-set-of-requirements comprising of a plurality of optional requirements which prepares for said job position by said verified employer;
d) executing a plurality of elected-candidates based on said first-candidates and said second-candidates;
e) notifying a specific number of said elected-candidates with a job offer;
f) posting said job posting in said calendar, and
g) collecting data from said screening, first-selecting, second-selecting, executing, notifying, and posting steps.

11. The method for screening, selecting and matching of claim 10, wherein said mandatory requirements selected from the groups consisting of a previous experience, a qualification, a level of education, an availability, and a physical distance from the job seeker to the verified employer.

12. The method for screening, selecting and matching of claim 10, wherein said optional requirements selected from the groups consisting of a physical characteristic, a level of maturity of profiles of said job seeker in social media websites.

13. The method for screening, selecting and matching of claim 10, wherein said environment comprises of a profile information of said job seeker and said verified employer, a communication channel, and a social media website.

14. The method for screening, selecting and matching of claim 10, wherein said screening comprises steps of:
a) collecting a set of information from said job seeker and said verified employer;
b) collecting a set of information from said communication channel; and
c) collecting a set of information from said social media websites, and
d) storing said set of information in said main database.

15. The method for screening, selecting and matching of claim 10, wherein said first-selecting comprises steps of:
a) reviewing said set of information;
b) comparing said set of information with said first-set-of-requirements, and
c) selecting a plurality of said first-candidates.

16. The method for screening, selecting and matching of claim 10, wherein said second-selecting comprises steps of:
a) reviewing said set of information;
b) comparing said set of information with said second-set-of-requirements, and
c) selecting a plurality of said second-candidates.

17. The method for screening, selecting and matching of claim 10, wherein said method further having a step to actively updating a match-level assigned to said job seeker based on said job posting.

18. A venue rental platform used by a verified specialty profile, wherein said specialty profile rents a venue for a short time, said platform comprising:
a) a screening computer-program implemented to screen an entire gathered data from an environment for said venue;
b) a first-set-of-requirements comprising of a plurality of mandatory requirements provided by said verified specialty profile for said venue;
c) a second-set-of-requirements comprising of a plurality of optional requirements provided by said verified specialty profile for said venue;
d) a first-selecting-computer-program implemented to select a plurality of first-venues based on said first-set-of-requirements;
e) a second-selecting-computer-program implemented to select a plurality of second-venues based on said second-set-of-requirements;
f) an executing-computer-program implemented to find a plurality of venues who appear in said first-venues and said second-venues, if no venues appears in both groups, then select from the first-venues;
g) a notification-computer-program implemented to notify a specific number of said elected-venues of booking;
h) a posting-computer-program implemented to fill said venue booking in a venue calendar and a specialty profile calendar;
i) a main database to collect data from said screening, first-selecting, second-selecting, executing, notification, and posting computer-programs, and
whereby the specialty profile pays and rates the elected-venue and the elected venue rates the verified specialty profile.

19. The venue rental platform of claim 18, wherein said specialty profile being selected from the groups consisting of DJs, promoters, event planners, and agencies.

20. The venue rental platform of claim 18, wherein said platform further has a computer-program implemented to show the number of participant which said event planner brings to said venue.
